(19) United States
(12) Patent Application Publication
(10) Pub. No.: US 2009/0256345 A1
(43) Pub. Date: Oct. 15, 2009

(54) FENDER LINER AND METHOD FOR PRODUCING THE SAME

(75) Inventors: Akimasa TANAKA, Komaki-shi (JP); Masahiko MORI, Kariya-shi (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/407,368

(22) Filed: Mar. 19, 2009

(30) Foreign Application Priority Data
Apr. 14, 2008 (JP) 2008-105072

(51) Int. Cl. B62D 25/18; B29C 43/46

(52) U.S. Cl. 280/850; 264/238

(57) ABSTRACT

The present invention provides a fender liner and a method for producing the same that allows reduction of noise caused by collision with pebbles etc. kicked by tires, that has sufficient rigidity, and that allows easier separation of attached ice. The fender liner comprises a low density nonwoven fabric layer, disposed on a side of the outside surface when it is attached to the outside surface, and a high density nonwoven fabric layer, the density of which is 0.6 to 0.9 g/cm³, in a thickness direction. The method comprises: obtaining a compound nonwoven fabric by intertwining and integrating a first and a second nonwoven fabric having predetermined amounts of mass per unit area and thicknesses respectively by a needle punching method; obtaining a nonwoven fabric laminated product for liners by heating the fabric from a side of the first nonwoven fabric layer with simultaneous pressurization; and die forming the product.

### CROSS-REFERENCE TO RELATED APPLICATIONS

The present application claims priority under 35 U.S.C. §119 of Japanese Patent Application No. 2008-105072, filed on Apr. 14, 2008, the disclosure of which is expressly incorporated by reference herein in its entirety.

### BACKGROUND OF THE INVENTION

1. Field of the Invention

The present invention relates to a fender liner and to a method for producing the fender liner. In more detail, the present invention relates to a fender liner that allows reduction of noise caused by collision with pebbles kicked by tires, reduction of splash noise during traveling in puddles etc., that has resistance to a wind pressure owing to sufficient rigidity even when attached to the fender on a side of a front wheel, and that allows easier separation of attached ice, and the present invention also relates to a method for producing the fender liner.

2. Description of the Related Art

Conventionally, fender liners are attached to the outside surface of a fender in order to protect a fender from collision of pebbles kicked by tires, and scattering and collision of the muddy water etc. in traveling in puddles, etc. Molded products using high density polyethylenes, and molded products using resin compositions including ethylene-propylene-diene rubbers blended with polypropylenes etc. have been known as the fender liners. The fender liners using the resins have high rigidity, and enable sufficient suppression of deformation, breakage, etc. of the fender liners by the collision of pebbles, etc.

However, the resins fail to demonstrate sound absorbing performance, and causes resonance vibration, exhibiting resultant lower sound insulating property. Therefore, sufficient reduction of engine noise and road noise may not be realized. Furthermore, since resins convert impacts, such as collision of pebbles etc., and scattering and collision of muddy water etc., into noises in frequency areas audible by human hearing, fender liners using the resins exhibit lower soundproof performance. Therefore, a fender liner is also known, wherein a sound absorbing material 4 including a nonwoven fabric etc. is attached on a predetermined spot of the surface facing the fender of the fender liner to improve soundproof performance (refer to FIG. 3). The fender liner, however, has a problem of cost increase in view of both materials and processes. Then, the fender liner using a nonwoven fabric is also proposed especially for use in a fender liner for a rear wheel (for example, refer to Related Arts 1 and 2).

[Related Art 1] Japanese Laid-open Patent Publication No. JP-A-2000-264255

[Related Art 2] Japanese Laid-open Patent Publication No. JP-A-2003-112661

However, although the fender liners using the existing nonwoven fabric described in Related Art 1 and Related Art 2 have some level of sound absorbing performance, it has low sound insulation performance and fails to exhibit sufficient soundproof performance. In addition, although the fender liner using the resin can secure sufficient rigidity by using a predetermined thickness, the fender liner using a nonwoven fabric exhibits lower rigidity. For this reason, the fender liner using a nonwoven fabric can be used as a fender liner for the rear wheel that receives smaller influence of a wind pressure in traveling, but the fender liner using a nonwoven fabric cannot be used as a fender liner for the front wheel that receives larger influence of the wind pressure. Furthermore, since the water attached to the fender liner penetrates inward, the ice formed reaches even inside when the penetrated water freezes, resulting in a problem of difficult separation of the ice.

### SUMMARY OF THE INVENTION

The present invention has been accomplished in view of the above-described conventional situation. An object of the present invention is to provide a fender liner that allows reduction of noise caused by collision by pebbles and gravels etc. kicked with tires during traveling of automobiles, reduction of splash noise caused by scattering and collision of the muddy water etc. during traveling in puddles, etc., and that has resistance against a wind pressure owing to sufficient rigidity even in case of attached to the fender on a side of a front wheel and allows easier separation of attached ice caused by freezing of attached water. Furthermore, another object of the present invention is to provide an easy method for producing a fender liner, wherein a compound nonwoven fabric obtained by intertwining of nonwoven fabrics having different mass per unit area and integration thereof is made to pass through, for example, between a pair of rolls with one roll being heated to manufacture a nonwoven fabric laminated product for liners, and then the laminated product is die formed.

The present invention is as follows.

1. A fender liner attached for use to an outside surface of a fender of an automobile, the fender liner comprising a low density nonwoven fabric layer and a high density nonwoven fabric layer in a thickness direction of the fender liner, wherein the low density nonwoven fabric layer is disposed on a side of the outside surface when the fender liner is attached to the outside surface, and a density of the high density nonwoven fabric layer is 0.6 to 0.9 g/cm³.

2. The fender liner described in above 1, wherein the low density nonwoven fabric layer has a density of 0.1 to 0.4 g/cm³.

3. The fender liner described in above 1, wherein an airflow rate is not more than 5 cm³/cm²/s.

4. The fender liner described in above 1, wherein the thickness of the fender liner is 2.0 to 5.0 mm, and the thickness of the high density nonwoven fabric layer is 0.05 to 0.5 mm.

5. The fender liner described in above 2, wherein an airflow rate is not more than 5 cm³/cm²/s.

6. The fender liner described in above 2, wherein the thickness of the fender liner is 2.0 to 5.0 mm, and the thickness of the high density nonwoven fabric layer is 0.05 to 0.5 mm.

7. The fender liner described in above 3, wherein the thickness of the fender liner is 2.0 to 5.0 mm, and the thickness of the high density nonwoven fabric layer is 0.05 to 0.5 mm.

8. The fender liner described in above 5, wherein the thickness of the fender liner is 2.0 to 5.0 mm, and the thickness of the high density nonwoven fabric layer is 0.05 to 0.5 mm.

9. A method for producing the fender liner described in above 1, the method comprising:

obtaining a compound nonwoven fabric having a first nonwoven fabric layer and a second nonwoven fabric layer by intertwining and integrating the first nonwoven fabric having an amount of mass per unit area of 75 to 300 g/m² and a thickness of 0.1 to 1.5 mm, and the second nonwoven fabric having an amount of mass per unit area of 350 to 900 g/m² and a thickness of 2.0 to 5.0 mm by a needle punching method;

subsequently obtaining a nonwoven fabric laminated product for liners by heating the compound nonwoven fabric from a side of the first nonwoven fabric layer with simultaneous pressurization in a thickness direction; and

subsequently die forming the nonwoven fabric laminated product for liners.

10. The method for producing the fender liner described in above 9, wherein the pressurizing and the heating are carried out by causing the compound nonwoven fabric to pass through between a pair of rolls with one roll being heated.

11. The method for producing the fender liner described in above 10, wherein the high density nonwoven fabric layer is formed onto at least a part of the first nonwoven fabric layer in a thickness direction from the surface of the compound nonwoven fabric facing the first nonwoven fabric layer.

12. The method for producing the fender liner described in above 11, wherein a resin fiber is bound for the first nonwoven fabric using a binder for binding, and at least a part of the binder for binding is made of a thermosetting resin binder.

13. The method for producing the fender liner described in above 12, wherein the binder for binding is 40 to 80 mass % when a sum total of the resin fiber and the binder for binding is set as 100 mass %, and the thermosetting resin binder is 20 to 50 mass % when the binder for binding is set as 100 mass %.

14. A method for producing the fender liner described in above 8, the method comprising:

obtaining a compound nonwoven fabric having a first nonwoven fabric layer and a second nonwoven fabric layer by intertwining and integrating the first nonwoven fabric having an amount of mass per unit area of 75 to 300 g/m² and a thickness of 0.1 to 1.5 mm, and the second nonwoven fabric having an amount of mass per unit area of 350 to 900 g/m² and a thickness of 2.0 to 5.0 mm by a needle punching method;

subsequently obtaining a nonwoven fabric laminated product for liners by heating the compound nonwoven fabric from a side of the first nonwoven fabric layer with simultaneous pressurization in a thickness direction; and

subsequently die forming the nonwoven fabric laminated product for liners.

15. The method for producing the fender liner described in above 14, wherein the pressurizing and the heating are carried out by causing the compound nonwoven fabric to pass through between a pair of rolls with one roll being heated.

16. The method for producing the fender liner described in above 15, wherein the high density nonwoven fabric layer is formed onto at least a part of the first nonwoven fabric layer in a thickness direction from the surface of the compound nonwoven fabric facing the first nonwoven fabric layer.

17. The method for producing the fender liner described in above 16, wherein a resin fiber is bound for the first nonwoven fabric using a binder for binding, and at least a part of the binder for binding is made of a thermosetting resin binder.

18. The method for producing the fender liner described in above 17, wherein the binder for binding is 40 to 80 mass % when a sum total of the resin fiber and the binder for binding is set as 100 mass %, and the thermosetting resin binder is 20 to 50 mass % when the binder for binding is set as 100 mass %.

The fender liner according to the present invention exhibits sufficient soundproof performance owing to a high density nonwoven fabric layer and a low density nonwoven fabric layer. The fender liner, even without sound absorbing materials, has higher soundproof performance than conventional fender liner that uses resins sound absorbing materials attached thereto. In addition, since the fender liner is a product made of nonwoven fabrics, it converts collision noises, such as noises by pebbles, into noises in frequency areas inaudible by human hearing, thereby reducing noise. Furthermore, since the fender liner has high rigidity and sufficient strength, it may be used also for a front-wheel side area wherein conventional fender liners using nonwoven fabrics are not able to be used. The fender liner facilitates handling in attaching to a fender, etc., also realizing weight saving. In addition, since the fender liner has a structure that allows attaching of water only on a side of the high density nonwoven fabric layer, it does not allow easy penetration of water inside. Furthermore, since it does not allow inside growth of the ice formed even in case of freezing of water, it facilitates easier separation of the ice, causing no problems.

When the low density nonwoven fabric layer has a density of 0.1 to 0.4 g/cm³, this low density nonwoven fabric layer has sufficient sound absorbing performance. For this reason, the fender liner may be obtained that has sound insulation performance owing to the high density nonwoven fabric layer and simultaneous sufficiently high soundproof performance.

Furthermore, when the fender liner has an airflow rate not more than 5 cm³/cm²/s, sufficient sound insulation performance may be obtained. The fender liner thus has more excellent soundproof performance and a denser surface part (on a side of the high density nonwoven fabric layer). Since the fender liner does not allow easy penetration of water and growth inward of the ice even in case of freezing of water, it facilitates easier separation of the ice.

In addition, when the fender liner has a thickness of 2.0 to 5.0 mm and the high density nonwoven fabric layer has a thickness of 0.05 to 0.5 mm, the fender liner may exhibit more outstanding soundproof performance and sufficiently high rigidity, and allow easy separation of attached ice.

According to the method for producing the fender liner of the present invention, the fender liner of the present invention can easily be produced by a simple method, wherein a nonwoven fabric laminated material for liners is obtained by heating a side of the nonwoven fabric layer having a larger density in the compound nonwoven fabric obtained by integration by intertwining of the nonwoven fabrics having different mass per unit area and thickness, and then this nonwoven fabric laminated material for liners obtained is die formed.

In addition, when pressurizing and heating of the compound nonwoven fabric are performed by causing it to pass through between a pair of rolls with one roll being heated, use of a simpler apparatus and a simpler operation enables easy production of the fender liner of the present invention.

Furthermore, when the high density nonwoven fabric layer is formed onto at least a part of a first nonwoven fabric layer in a thickness direction from the surface of the first nonwoven fabric layer, of the compound nonwoven fabric, a fender liner may be obtained that has especially outstanding soundproof performance and high rigidity and allows easy separation of attached ice.

Here, the resin fiber is bound for the first nonwoven fabric using the binder for binding. When at least a part of the binder for binding is made of a thermosetting resin binder, the high-densified nonwoven fabric layer does not restore the low-density state and the density is not reduced in subsequent heating in, for example, die forming. Consequently, the present invention can easily produce a fender liner having the high density nonwoven fabric layer with a predetermined density, while avoiding reduction of the density.

Furthermore, the present invention can easily produce a more uniform fender liner having a high density nonwoven fabric layer with a predetermined density, in the case where the binder for binding is 40 to 80 mass % when the sum total of the resin fiber and the binder for binding is set as 100 mass %, and in the case where the thermosetting resin binder is 20 to 50 mass % when the binder for binding is set as 100 mass %.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view for describing a mounting position of a fender liner in an automobile;

FIG. 2 is a schematic perspective view showing the fender liner of the present invention;

FIG. 3 is a schematic perspective view showing an example of a conventional resin-made fender liner, the fender liner having a sound absorbing material attached to a necessary place thereof facing a side attached to the fender;

FIG. 4 is a schematic sectional view showing a compound nonwoven fabric obtained by intertwining and integration of a first nonwoven fabric and a second nonwoven fabric;

FIG. 5 is a schematic illustration of a process of producing a nonwoven fabric laminated product for liners, wherein a compound nonwoven fabric is made to pass between a pair of rolls with one roll being heated, to be heated from the side facing the first nonwoven fabric layer while being pressurized; and

FIG. 6 is a schematic sectional view showing a part of a fender liner having a high density nonwoven fabric layer and a low density nonwoven fabric layer.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

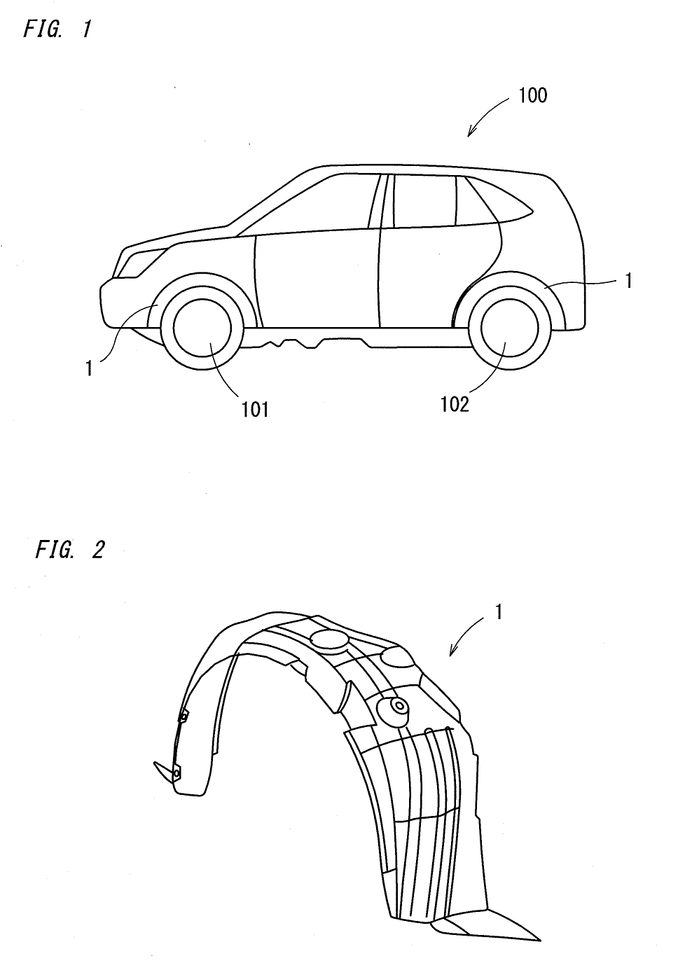

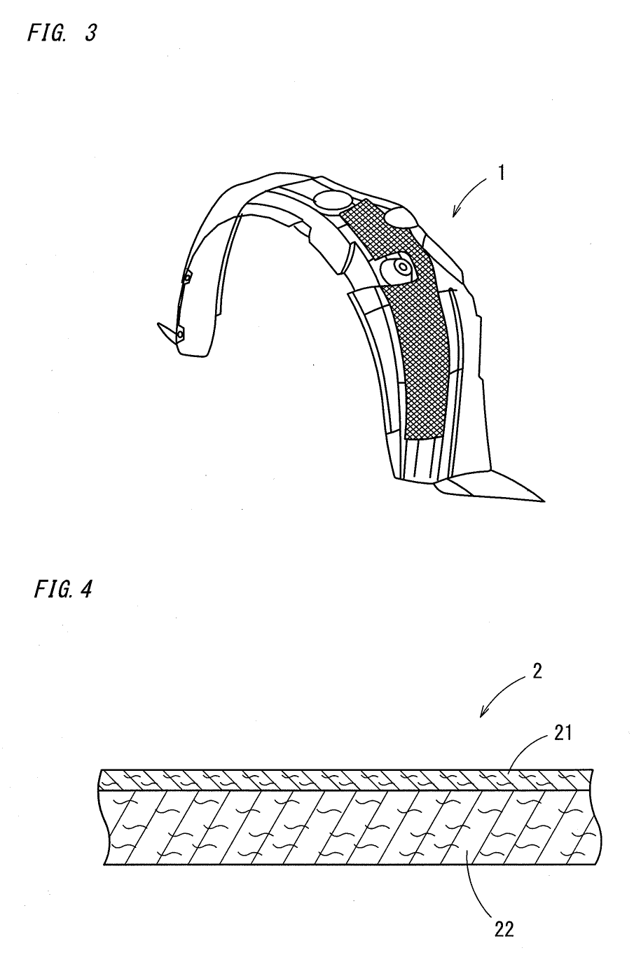

Hereinafter, the present invention will be described in detail with reference to FIGS. 1 to 2 and 4 to 6.

1. Fender Liner

A fender liner of the present invention is attached to the outside surface of a fender of an automobile. This fender liner is provided with a low density nonwoven fabric layer and a high density nonwoven fabric layer in a thickness direction thereof. When attached to the outside surface of the fender, the low density nonwoven fabric layer is to be disposed in the outside surface of the fender, and the high density nonwoven fabric layer has a density of 0.6 to 0.9 g/cm³ (refer to FIG. 6).

The above-described “fender liner 1” is used to be attached on the outside surface of the fender of the automobile 100 (refer to FIG. 1). Especially the fender liner 1 is an indispensable exterior component for automobile, such as a passenger car, that needs sufficient soundproof performance etc. Since the fender liner 1 of the present invention has high rigidity despite being made of a nonwoven fabric, the fender liner 1 may be used not only in a rear-wheel 102 side, but in the fender on the front wheel 101 that can be largely affected by a wind pressure in traveling. In addition, the fender liner 1 has the same shape as that of normal fender liners, and is provided with a notch section through which a suspension shaft is made to pass, a clip hole for receiving a clip projected on the outside surface of the fender in order to attach the fender liner, and the like (refer to FIG. 2).

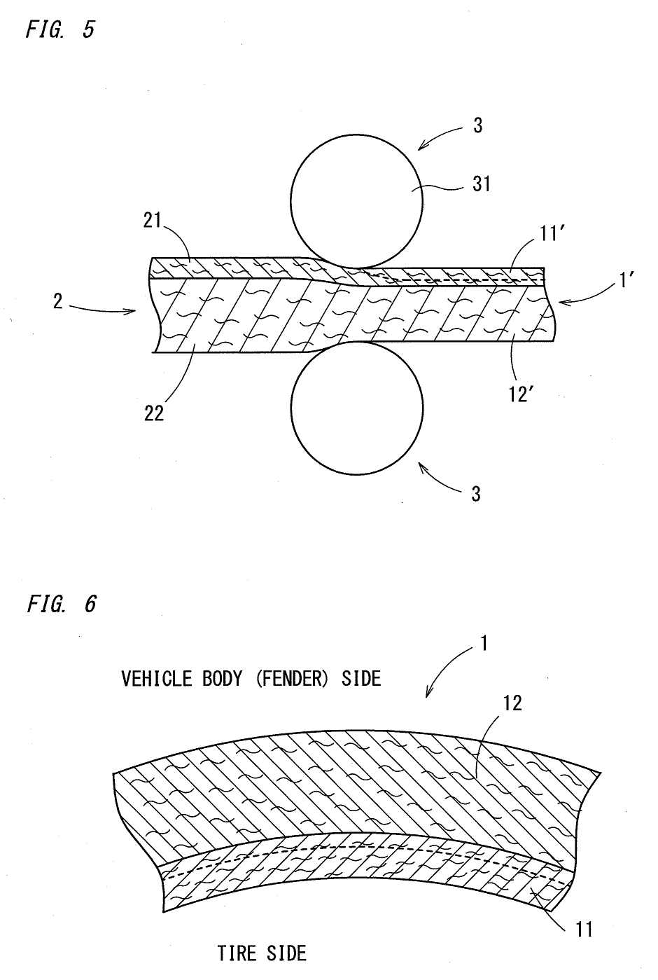

When the fender liner 1 is attached to the fender, the above-described “high density nonwoven fabric layer 11” (refer to FIG. 6, the broken line in FIG. 6 designates the boundary between the high density nonwoven fabric layer 11 and the low density nonwoven fabric layer 12, and the nonwoven fabric layer 11 is equivalent to a nonwoven fabric layer 11′ of a nonwoven fabric laminated product 1′ for liners in FIG. 5) is disposed at the tire side, and forms a side to which pebbles, water, etc. collide and pollution etc. is to be attached. Therefore, the fender liner 1 needs to have a sufficiently high density, in order to resist to impact, and to avoid easy penetration of water inside. The density of the high density nonwoven fabric layer is 0.6 to 0.9 g/cm³, and preferably 0.75 to 0.85 g/cm³. When the density of the high density nonwoven fabric layer is 0.6 to 0.9 g/cm³, the fender liner can sufficiently resist to impact, and in particular, does not allow easy penetration of water inside. As a consequence, the ice formed does not grow inward when the attached water freezes, resulting in easy separation of the ice from the fender liner.

The above-described “low density nonwoven fabric layer 12” (refer to FIG. 6) is disposed on the fender side, when the fender liner is attached to the fender, so that the sound absorbing performance of the low density nonwoven fabric layer provides more outstanding soundproof performance and higher rigidity to the fender liner. The density of the low density nonwoven fabric layer is not especially limited as long as it is lower than the density of the high density nonwoven fabric layer, and it is preferably 0.1 to 0.4 g/cm³, and more preferably 0.1 to 0.3 g/cm³. The density of the low density nonwoven fabric layer in the range of 0.1 to 0.4 g/cm³ provides sufficient soundproof performance, and also provides the fender liner having high rigidity.

In order to improve the soundproof performance of the fender liner, a smaller airflow rate is preferred. The airflow rate of the fender liner measured according to JIS L 1096 8.27.1 [A method (Frazier method)] is preferably not more than 5 cm³/cm²/s, and more preferably not more than 2 cm³/cm²/s. It is believed that the airflow rate of the fender liner is greatly affected by the density and the thickness, etc. of the high density nonwoven fabric layer. When the airflow rate of the fender liner is not more than 5 cm³/cm²/s, a fender liner can be obtained that has outstanding soundproof performance by synergetic effect of the sound insulation performance of the high density nonwoven fabric layer, and of the sound absorbing performance of the low density nonwoven fabric layer.

Note that the fender liner does not need to exhibit substantial air permeability. Here, the phrase “it does not have air permeability” as used herein designates that the airflow rate measured by the above-described method is less than a limit-of-measurement value.

The thickness of the fender liner is not in particular limited, but it is preferably 2.0 to 5.0 mm, and more preferably 2.5 to 3.5 mm. Furthermore, the thickness of the high density nonwoven fabric layer is not especially limited either, but it is 0.05 to 0.5 mm, preferably 0.05 to 0.3 mm, and more preferably 0.1 to 0.2 mm. The thickness of the fender liner in the range of 2.0 to 5.0 mm, and the thickness of the high density nonwoven fabric layer in the range of 0.05 to 0.5 mm can provide outstanding soundproof performance, high rigidity, and sufficient resistance against the wind pressure in traveling. Furthermore, they facilitate operations such as attaching to the fender, and also allow avoidance of the growth of attached ice inward and easy separation thereof.

2. Method for Producing Fender Liner

In a method for producing the fender liner of the present invention, a first nonwoven fabric having an amount of mass per unit area of 75 to 300 g/m² and a thickness of 0.1 to 1.5 mm, and a second nonwoven fabric having an amount of mass per unit area of 350 to 900 g/m² and a thickness of 2.0 to 5.0 mm are intertwined by a needle punching method to be integrated, thereby to obtain a compound nonwoven fabric having the first nonwoven fabric layer and the second nonwoven fabric layer. Subsequently, the compound nonwoven fabric is heated from the side of the first nonwoven fabric layer while being pressurized in its thickness direction, to obtain a nonwoven fabric laminated product for liners, and in the next step, the nonwoven fabric laminated product for liners is die formed.

The amount mass per unit area of the “first nonwoven fabric” is 75 to 300 g/m² and is preferably 100 to 280 g/m². Furthermore, the thickness of the first nonwoven fabric is 0.1 to 1.5 mm and is preferably 0.3 to 1.3 mm. The amount of mass per unit areas of 75 to 300 g/m² and the thickness of 0.1 to 1.5 mm enable easy formation of the high density nonwoven fabric layer having a predetermined thickness. The material of the resin fiber for forming the first nonwoven fabric is not in particular limited, and examples thereof include polyester fibers such as polyethylene terephthalate fibers and polybutylene terephthalate fibers; polyamide fibers such as nylon 6 fibers and nylon 66 fibers; polyolefin fibers such as polyethylene fibers and polypropylene fibers; and acrylic fibers such as polymethylmethacrylate fibers.

The first nonwoven fabric is produced by the thermal bonding method. In this case, available as the binder used for the binding of the resin fiber is a fiber for binder to be melted at a temperature lower than the melting temperature of the resin fiber. Various kinds of resin fibers that form the first nonwoven fabric may be used as the fiber for binders. Especially preferable are fibers for binders including polyolefin fibers and polyester fibers that melt at lower temperatures to allow binding of the resin fiber. Furthermore, among the polyolefin fibers and the polyester fibers, more preferred are, for example, shell and core fibers having a core of polypropylene and a shell of polyethylene; shell and core fibers having a core of high melting point polyester and a shell of low melting point polyester; and side-by-side fibers made of polypropylene and polyethylene.

The mass proportion of the binder for binding is not in particular limited, but it is preferably 40 to 80 mass %, and particularly preferably 50 to 70 mass % when the sum total of the resin fiber and the binder for binding is defined as 100 mass %. The mass proportion of the binder for binding in the range of 40 to 80 mass % enables easy production of the first nonwoven fabric having a predetermined amount of mass per unit area and a predetermined thickness.

At least a part of the binder for binding is preferably a thermosetting resin binder. The mass proportion of the thermosetting resin binder is not in particular limited, but it is preferably 20 to 50 mass %, and particularly preferably 30 to 40 mass % when the amount of the binder for binding is defined as 100 mass %. The mass proportion of the thermosetting resin binder in the range of 20 to 50 mass % is preferable because a predetermined high density is maintained while avoiding the reconstruction by heating and the reduction of the density, for example, in subsequent die forming etc., of the high density nonwoven fabric layer that has been pressurized and heated to be formed. The thermosetting resin binder is not in particular limited, and includes binders, such as amorphous polyesters and phenols.

The amount of mass per unit area of the “second nonwoven fabric” is 350 to 900 g/m² and is preferably 400 to 800 g/m². Furthermore, the thickness of the second nonwoven fabric is 2.0 to 5.0 mm and is preferably 2.2 to 4.0 mm. The amount of mass per unit area of 350 to 900 g/m² and the thickness of 2.0 to 5.0 mm may provide the low density nonwoven fabric layer having sufficient sound absorbing performance, resulting in the fender liner having outstanding soundproof performance. The material of the resin fiber that forms the second nonwoven fabric is not in particular limited, and various kinds of resin fibers that form the first nonwoven fabric may be used without any special limitation.

Since there is no need to form the high density nonwoven fabric layer in the second nonwoven fabric layer of the compound nonwoven fabrics, the method of producing the second nonwoven fabric is not in particular limited, and therefore nonwoven fabrics produced by various kinds of methods, such as a thermal bonding method and a needle punching method, may be used. In the case of using the second nonwoven fabric produced by the thermal bonding method, fibers for binder to be melted at a temperature lower than the melting temperature of the resin fiber are used as the binder used for the binding of the resin fiber. Available as the fibers for binder are various kinds of fibers for binder exemplified in the first nonwoven fabric described above. The fibers for binder including polyolefin fibers and polyester fibers is preferable as in the above-described case, and shell and core fibers, side by side fibers, etc. are more preferable.

The “compound nonwoven fabric 2” (refer to FIGS. 4 and 5) is made by intertwining and integrating between the first nonwoven fabric and second nonwoven fabric by the needle punching method, and has the “first nonwoven fabric layer 21” and the “second nonwoven fabric layer 22”. Furthermore, the “nonwoven fabric laminated product for liners 1” (refer to FIG. 5: the broken line in FIG. 5 designates the boundary between a nonwoven fabric layer 11′ serving as the high density nonwoven fabric layer, and a nonwoven fabric layer 12′ serving as the low density nonwoven fabric layer: the nonwoven fabric layer 11′ is formed by heating and pressurizing the first nonwoven fabric layer 21 in a part in the thickness direction) may be produced by heating from a side of the first nonwoven fabric layer 21 while pressurizing the compound nonwoven fabric 2. The pressing force and the heating temperature are not in particular limited, and are preferably determined considering elements such as the density and thickness of the high density nonwoven fabric layer of the fender liner, the density of the low density nonwoven fabric layer of the fender liner, and the whole thickness of the fender liner.

The method of the pressurizing and heating the compound nonwoven fabric 2 is not in particular limited, and includes a method of passing the material between a pair of rolls and a method of using a press-forming apparatus. In the case of using a pair of rolls 3 (refer to FIG. 5), one roll is heated (heating roll 31), and the other roll is kept at ambient temperatures, or cooled if needed. Thus, the compound nonwoven fabric 2 may be pressurized and heated between the rolls. In the case of using a press-forming apparatus, one press plate is heated, and the other plate is kept at ambient temperatures, or cooled if needed. Thus, the compound nonwoven fabric 2 may be pressurized and heated between the press plates. Of these methods, the method of using a pair of rolls is preferable. This method enables continuous and efficient production of the nonwoven fabric laminated product 1′ for liners that has the nonwoven fabric layer 11′ serving as the high density nonwoven fabric layer formed thereon, on at least a part in the thickness direction of the surface of the compound nonwoven fabric 2 on the side of the first nonwoven fabric layer 21.

The method of die forming using the nonwoven fabric laminated product for liners is not especially limited, either. For example, the nonwoven fabric laminated product for liners is mounted in a forming die having a predetermined cavity and controlled to a predetermined temperature based on the shape and the dimension of the fender liner, and is heated and pressurized to be die-formed. Alternatively, the nonwoven fabric laminated product for liners beforehand heated to a predetermined temperature may also be pressurized and die-formed, using a forming die cooled to a predetermined temperature based on an ambient temperature or necessity.

### EXAMPLES

Hereinafter, the present invention will be described in detail with reference to the following examples.

### Example 1

1. Production of Fender Liner

A first nonwoven fabric having an amount of mass per unit area of 250 g/m² and a thickness of 1 mm was obtained by a thermal bonding method, using 30 mass % of a polyethylene terephthalate (PET) fiber as a resin fiber; 30 mass % of a shell and core fiber including a PET as a core with a melting point of 260° C. and a PET as a shell with a melting point of 110° C., as a binder for binding; and 40 mass % of a thermosetting resin binder. A second nonwoven fabric having an amount of mass per unit area of 750 g/m² and a thickness of 3 mm was obtained by the thermal bonding method, using 50 mass % of a polyethylene terephthalate (PET) fiber as a resin fiber; and 50 mass % of a shell and core fiber including a PET as a core with a melting point of 260° C. and a PET as a shell with a melting point of 110° C., as a binder for binding.

Subsequently, the first nonwoven fabric and the second nonwoven fabric were intertwined and integrated by a needle punching method, to produce a compound nonwoven fabric. Then, the compound nonwoven fabric was made to pass through between a pair of rolls such that a side of the first nonwoven fabric layer was contacted with a heated roll, to produce a nonwoven fabric laminated product for liners. This nonwoven fabric laminated product for liners was mounted in a fender liner molding die, and heated and pressurized to produce a fender liner having a thickness of 3 mm and a mass of 1000 g/m².

Here, the density of the high density nonwoven fabric layer gave a value of 0.75 g/cm³, and the thickness a value of 0.25 mm.

2. Evaluation of Physical Properties

A test piece was cut out from the fender liner produced in 1. above. This test piece was measured for:

(1) Airflow rate;

(2) Separation strength in separation of attached ice;

(3) Bending load as an index for rigidity; and

(4) AI value (conversation articulation score).

(1) Airflow Rate

The airflow rate was measured according to JIS L 1096 8.27.1 [A method (Frazier method)]. As a result, the airflow rate gave a value of 1.0 cm³/cm²/s.

(2) Separation Strength

A cylindrical jig having 43 mm of inside diameter, 47 mm of outside diameter, and 28 mm of a height was forced to stand on a test piece in a thermostat with a temperature adjusted to −20° C. 40.6 ml of water was gradually blown on the inside of the jig by a spray to grow ice thereon. Subsequently, the central part in a width direction (upper and lower direction) of a plate-shaped material, horizontally projected in the center section in a height direction on the outer wall of the jig, was pulled up upward by a push pull gage at a position 20 mm distant from the outer wall of the jig. In this condition, the separation strength when the attached ice was separated from the test piece was read. As a result, the separation strength gave a value of 12N, and it is understood that the attached ice on this fender liner here will be easily separated.

(3) Rigidity (Bending Load)

A test piece was placed perpendicularly to the walls on upper surfaces of walls of a jig having the walls standing parallel on both ends, such that the center section between the walls and the center section in a lengthwise direction of the test piece might meet with each other. The center section in the lengthwise direction of the test piece was pressurized by the jig of the Autograph for pushing down. When the pushing down length reached 20 mm from a horizontal position, a maximum bending load was read. As a result, the maximum bending load was 21 N, showing this fender liner having a sufficient rigidity.

(4) AI Value

An A-weighted sound pressure level to the frequency band for every ⅓ octave band of 100 to 6300 Hz for driving noise was measured for at positions corresponding to the ears of a crew member in a driver's seat and a passenger seat in traveling using an actual vehicle at 100 km/h (a jig was attached to a seat headrest, and a microphone was fixed to the positions corresponding to the crew member's ears with this jig). An AI (Articulation Index) value serving as an index of a conversation articulation score based on this measured value was calculated. As a result, the AI value was 86.0% (an average value of a driver's seat and a passenger seat), allowing clear listening comprehension of conversation.

### Comparative Example 1

A compound nonwoven fabric was produced in the same manner as in Example 1, except that used was a first nonwoven fabric having an amount of mass per unit area of 250 g/m² and a thickness of 0.5 mm, the first nonwoven fabric being obtained by a thermal bonding method using 50 mass % of a PET fiber as a resin fiber; and 50 mass % of a shell and core fiber including a PET as a core with a melting point of 260° C. and a PET as a shell with a melting point of 110° C., as a binder for binding. In the same manner as in Example 1, a nonwoven fabric laminated product for liners having a thickness of 4 mm, and further a fender liner having a thickness of 3 mm and a mass of 1000 g/m² were produced.

This fender liner was evaluated for physical properties in the same manner as in Example 1. The airflow rate was 30.0 cm³/cm²/s; the separation strength was 36 N; the bending load was 11.5 N; and the AI value was 82.6%. Thus, since this fender liner has a large airflow rate and a low soundproof performance, the AI value is low. In addition, it is understood that the fender liner does not allow easy separation of attached ice owing to a large separation strength, and that the fender liner would exhibit a lower wind pressure resistance compared with that of the fender liner in Example 1 since it has a smaller bending load.

### Comparative Example 2

A fender liner having the same shape as that in Example 1, with a thickness of 1.3 mm and amass of 1300 g/m², was produced using a high density polyethylene sheet. When a test piece cut out was evaluated for physical properties as in Example 1, the airflow rate was 0 cm³/cm²/s; the separation strength was 10 N; the bending load was 5.2 N; and the AI value was 81.8%. As this example shows, it is understood that the conventional fender liner made of resin does not allow air flow therethrough and has a low soundproof performance, and that it allows easy separation of attached ice owing to a smaller separation strength. However, it is understood that since the conventional fender liner has a small bending load, it has a lower wind pressure resistance compared with the wind pressure resistance of the fender liner in Example 1.

### Comparative Example 3

A hard resin plate obtained by binding a polyester fiber with a hard styrene butadiene rubber as a binder was die formed to give a fender liner having a thickness of 2 mm and a mass of 1000 g/m². A test piece was cut out from the fender liner for evaluation (excluding AI value) in the same manner as in Example 1. Test results gave an airflow rate of 50 cm³/cm²/s; a separation strength of 45 N; and a bending load of 1.3 N. As the results show, the fender liner obtained by the nonwoven fabric in Comparative Example 3 has a large airflow rate and a low soundproof performance. In addition, it is understood that the fender liner does not allow easy separation of attached ice owing to a large separation strength, and that the fender liner would exhibit a lower wind pressure resistance compared with that of the fender liner in Example 1 since it has a smaller bending load.

### Comparative Example 4

A fender liner was obtained using a nonwoven fabric plate obtained by binding a polyamide fiber by use of a polyester fiber as a binder. A test piece was cut out from the fender liner for evaluation (excluding AI value) in the same manner as in Example 1. Test results gave an airflow rate of 30 cm³/cm²/s; a separation strength of 43 N; and a bending load of 2.0 N. As the results show, the fender liner obtained by the nonwoven fabric in Comparative Example 4 has a large airflow rate and a low soundproof performance. In addition, it is understood that the fender liner does not allow easy separation of attached ice owing to a large separation strength, and that the fender liner would exhibit a lower wind pressure resistance compared with that of the fender liner in Example 1 since it has a smaller bending load.

The fender liner of the present invention has a sufficient soundproof performance and a high rigidity and allows easy separation of attached ice. Accordingly, the fender liner may be used as a fender liner not only for the fender in the rear wheel of an automobile, especially various kinds of passenger cars, but for the fender in the front wheel.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A fender liner attached for use to an outside surface of a fender of an automobile, the fender liner comprising a low density nonwoven fabric layer and a high density nonwoven fabric layer in a thickness direction of the fender liner, wherein the low density nonwoven fabric layer is disposed on a side of the outside surface when the fender liner is attached to the outside surface, and a density of the high density nonwoven fabric layer is 0.6 to 0.9 g/cm³.

2. The fender liner according to claim 1, wherein the low density nonwoven fabric layer has a density of 0.1 to 0.4 g/cm³.

3. The fender liner according to claim 1, wherein an airflow rate is not more than 5 cm³/cm²/s.

4. The fender liner according to claim 1, wherein the thickness of the fender liner is 2.0 to 5.0 mm, and the thickness of the high density nonwoven fabric layer is 0.05 to 0.5 mm.

5. The fender liner according to claim 2, wherein an airflow rate is not more than 5 cm³/cm²/s.

6. The fender liner according to claim 2, wherein the thickness of the fender liner is 2.0 to 5.0 mm, and the thickness of the high density nonwoven fabric layer is 0.05 to 0.5 mm.

7. The fender liner according to claim 3, wherein the thickness of the fender liner is 2.0 to 5.0 mm, and the thickness of the high density nonwoven fabric layer is 0.05 to 0.5 mm.

8. The fender liner according to claim 5, wherein the thickness of the fender liner is 2.0 to 5.0 mm, and the thickness of the high density nonwoven fabric layer is 0.05 to 0.5 mm.

9. A method for producing the fender liner according to claim 1, the method comprising:
obtaining a compound nonwoven fabric having a first nonwoven fabric layer and a second nonwoven fabric layer by intertwining and integrating the first nonwoven fabric having an amount of mass per unit area of 75 to 300 g/m² and a thickness of 0.1 to 1.5 mm, and the second nonwoven fabric having an amount of mass per unit area of 350 to 900 g/m² and a thickness of 2.0 to 5.0 mm by a needle punching method;
subsequently obtaining a nonwoven fabric laminated product for liners by heating the compound nonwoven fabric from a side of the first nonwoven fabric layer with simultaneous pressurization in a thickness direction; and
subsequently die forming the nonwoven fabric laminated product for liners.

10. The method for producing the fender liner according to claim 9, wherein the pressurizing and the heating are carried out by causing the compound nonwoven fabric to pass through between a pair of rolls with one roll being heated.

11. The method for producing the fender liner according to claim 10, wherein the high density nonwoven fabric layer is formed onto at least a part of the first nonwoven fabric layer in a thickness direction from the surface of the compound nonwoven fabric facing the first nonwoven fabric layer.

12. The method for producing the fender liner according to claim 11, wherein a resin fiber is bound for the first nonwoven fabric using a binder for binding, and at least a part of the binder for binding is made of a thermosetting resin binder.

13. The method for producing the fender liner according to claim 12, wherein the binder for binding is 40 to 80 mass % when a sum total of the resin fiber and the binder for binding is set as 100 mass %, and the thermosetting resin binder is 20 to 50 mass % when the binder for binding is set as 100 mass %.

14. A method for producing the fender liner according to claim 8, the method comprising:
obtaining a compound nonwoven fabric having a first nonwoven fabric layer and a second nonwoven fabric layer by intertwining and integrating the first nonwoven fabric having an amount of mass per unit area of 75 to 300 g/m² and a thickness of 0.1 to 1.5 mm, and the second nonwoven fabric having an amount of mass per unit area of 350 to 900 g/m² and a thickness of 2.0 to 5.0 mm by a needle punching method;
subsequently obtaining a nonwoven fabric laminated product for liners by heating the compound nonwoven fabric from a side of the first nonwoven fabric layer with simultaneous pressurization in a thickness direction; and
subsequently die forming the nonwoven fabric laminated product for liners.

15. The method for producing the fender liner according to claim 14, wherein the pressurizing and the heating are carried out by causing the compound nonwoven fabric to pass through between a pair of rolls with one roll being heated.

16. The method for producing the fender liner according to claim 15, wherein the high density nonwoven fabric layer is formed onto at least a part of the first nonwoven fabric layer in a thickness direction from the surface of the compound nonwoven fabric facing the first nonwoven fabric layer.

17. The method for producing the fender liner according to claim 16, wherein a resin fiber is bound for the first nonwoven fabric using a binder for binding, and at least a part of the binder for binding is made of a thermosetting resin binder.

18. The method for producing the fender liner according to claim 17, wherein the binder for binding is 40 to 80 mass % when a sum total of the resin fiber and the binder for binding is set as 100 mass %, and the thermosetting resin binder is 20 to 50 mass % when the binder for binding is set as 100 mass %.
